(19) United States
(12) Patent Application Publication
(10) Pub. No.: US 2006/0234586 A1
(43) Pub. Date: Oct. 19, 2006

(54) Low density, high loft nonwoven substrates

(75) Inventors: Arthur Wong, West Chester, OH (US); Jeffrey Lawrence Flora, Mason, OH (US); John Brian Strube, Okeana, OH (US); Ali Abdelaziz Alwattari, Pointe Claire (CA); Rajeev Chhabra, Mason, OH (US)

Correspondence Address: THE PROCTER & GAMBLE COMPANY;INTELLECTUAL PROPERTY DIVISION, WINTON HILL BUSINESS CENTER - BOX 161, 6110 CENTER HILL AVENUE, CINCINNATI, OH, 45224, US

(73) Assignee: The Procter & Gamble Company

(21) Appl. No.: 11/455,972

(22) Filed: Jun. 20, 2006

Related U.S. Application Data
(63) Continuation of application No. 10/648,942, filed on Aug. 27, 2003.
(60) Provisional application No. 60/406,855, filed on Aug. 29, 2002.

(51) Int. Cl. D04H 1/00; D04H 1/46; D04H 3/16; D04H 13/00; B32B 3/04

(52) U.S. Cl. 442/327; 442/401; 442/415; 442/408; 428/121

(57) ABSTRACT

The present invention relates to a nonwoven substrate suitable for use as a cleaning sheet having density of no more than 0.15 g/cm³ and comprising at least one fibrous web, said substrate comprising at least one first region and at least one second region wherein said second region comprises protruding elements and is capable of greater geometric deformation than said first region. The present invention also relates to the use of said substrates as cleaning sheets, a process of cleaning soiled surfaces with said substrates and a method of making said substrates.

### CROSS REFERENCE TO RELATED APPLICATIONS

This application claims the benefit of U.S. Provisional Application No. 60/406,855 filed Aug. 29, 2002.

### FIELD OF THE INVENTION

The present invention relates to nonwoven substrates, having low density, preferably high loft and which comprise at least one fibrous web, at least a first region and at least a second region wherein the second region comprises at least one protruding element and is capable of greater geometric deformation than the first region. The second region preferably comprises protruding rib-like and/or folding elements within or on the surface of the substrate. The present invention also relates to a process capable of producing substrates having the described first and second regions and preferably protruding rib-like and/or folding elements within or on the surface of the substrate.

The substrates of the present invention have a wide range of potential uses, but are particularly well suited for use as disposable surface care products such as dry dusting sheets, wet and dry floor cleaning wipes/pads, wet and dry counter wipes, and the like.

### BACKGROUND OF THE INVENTION

The use of nonwoven sheets for cleaning surfaces are known in the art. Such sheets typically utilize a composite of fibers where the fibers are bonded via adhesive, entangling or other forces. See, for example, U.S. Pat. No. 3,629,047 and U.S. Pat. No. 5,144,729. To provide a durable wiping sheet, reinforcement means have been combined with the staple fibers in the form of a continuous filament or network structure. See, for example, U.S. Pat. No. 4,808,467, U.S. Pat. No. 3,494,821 and U.S. Pat. No. 4,144,370. Also, to provide a product capable of withstanding the rigors of the wiping process, prior nonwoven sheets have employed strongly bonded fibers via one or more of the forces mentioned above. While durable materials are obtained, such strong bonding may adversely impact the materials' ability to pick up and retain particulate dirt. In an effort to address this concern, U.S. Pat. No. 5,525,397 to Shizuno et al. describes a cleaning sheet comprising a polymeric network layer and at least one nonwoven layer, wherein the two layers are lightly hydroentangled so as to provide a sheet having a low entanglement coefficient. The resulting sheet is said to provide strength and durability, as well as improved dust collecting performance because the composite fibers are lightly hydroentangled. Sheets having a low entanglement coefficient (i.e., not more than 500 m) are said to offer better cleaning performance because a greater degree of fibers are available for contact with dirt.

While the sheets described in the '397 patent are alleged to address some of the problems with prior nonwoven cleaning sheets, those sheets appear to be generally uniform, at least on a macroscopic level and are essentially of a uniform caliper, again on a macroscopic level. However a sheet having such uniformity is not particularly suitable for collecting and entrapping soil of a diverse size, shape, etc.

As such, there is a continuing need to provide cleaning sheets that offer improved soil removal, collection and entrapment. Accordingly, it is an object of this invention to overcome the problems of the prior art and particularly to provide a structure more capable of removing, collecting and entrapping various types of soil. Specifically, it is an object of the present invention to provide a nonwoven substrate having significant three-dimensionality and thus provide a cleaning sheet exhibiting enhanced soil removal, collection and entrapment.

### SUMMARY OF THE INVENTION

The present invention relates to a nonwoven substrate suitable for use as a cleaning sheet having density of no more than 0.15 g/cm³ and comprising at least one fibrous web, said substrate further comprising at least one first region and at least one second region wherein said second region comprises protruding elements and is capable of greater geometric deformation than said first region.

In a preferred embodiment the present invention relates to a nonwoven substrate wherein the second regions comprise protruding rib-like structures and/or folding elements within or on the surface of the sheet.

The present invention also relates to a process of forming the above substrate wherein the substrate is fed through a pair of corresponding rolls (502 and 504) at least one of said pair of rolls (502) comprising at least one, preferably a plurality of toothed (506) and grooved (508) regions about the circumference of the rolls, said grooved regions forming the first regions of the substrate and said toothed regions forming the second regions of the substrate.

### BRIEF DESCRIPTION OF THE DIAGRAMS

While the specification concludes with claims particularly pointing out and distinctly claiming the present invention, it is believed that the present invention will be better understood from the following description in conjunction with the accompanying drawings, in which like reference numerals identify like elements and wherein:

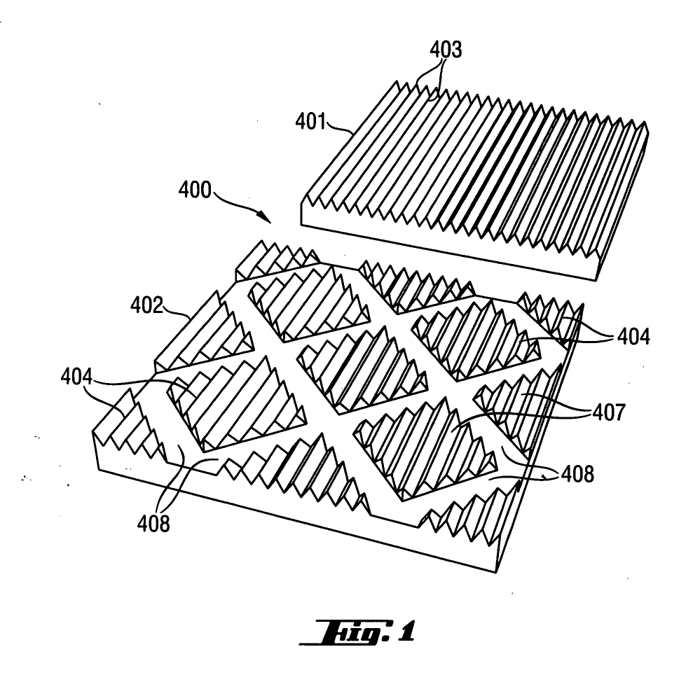

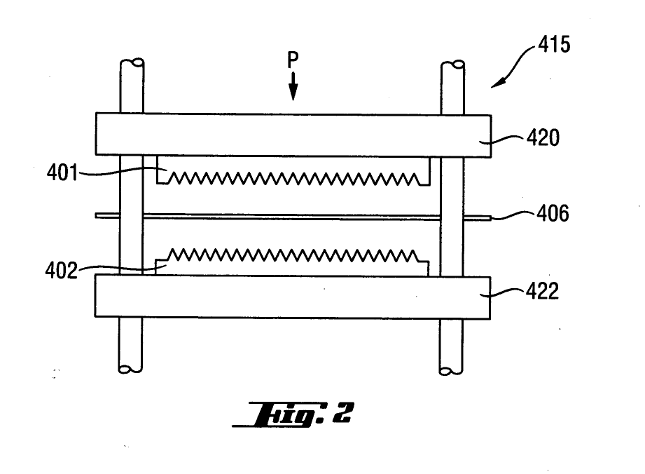

FIG. 1 is a simplified perspective view of a preferred apparatus used to form substrates of the present invention with a portion of the apparatus being tilted to expose the teeth.

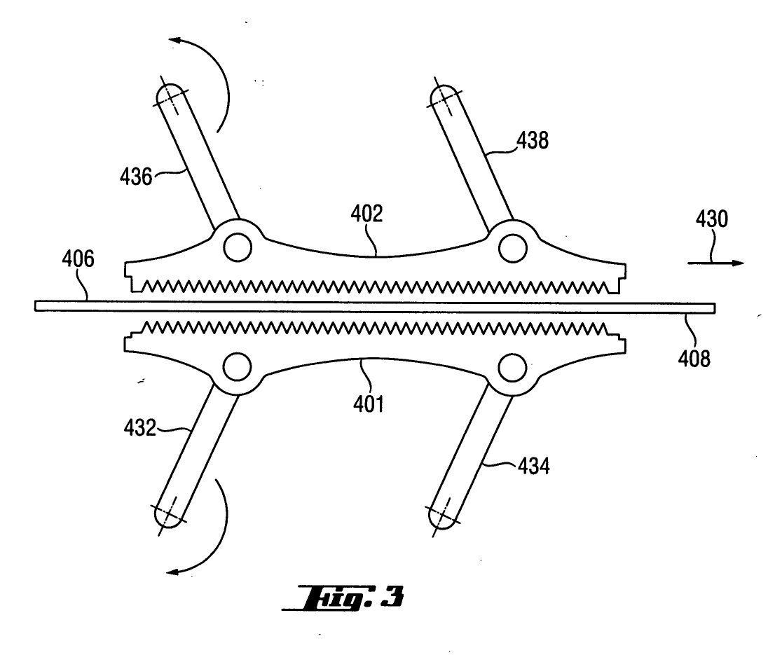

FIG. 2 is a simplified side elevation view of a static press used to form the substrate of the present invention.

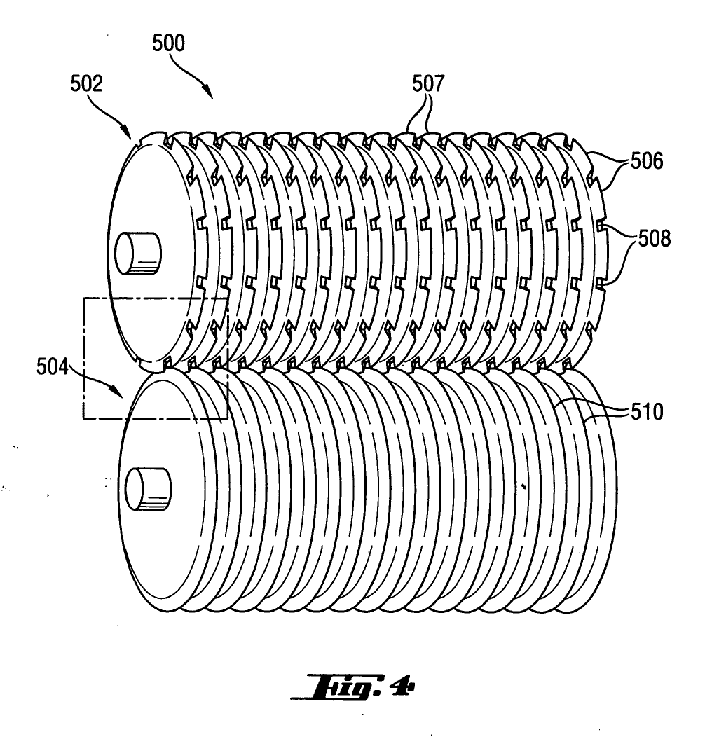

FIG. 3 is a is a simplified side elevation view of a continuous, dynamic press used to form the substrates of the present invention.

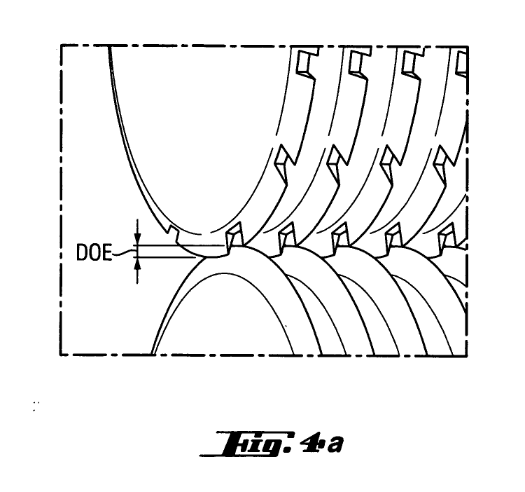

FIG. 4. is a simplified illustration of another apparatus used to form the substrates of the present invention.

FIG. 4a. is a blown up illustration of the boxed area in FIG. 4, showing the distance of depth of engagement (DOE) of two corresponding rolls.

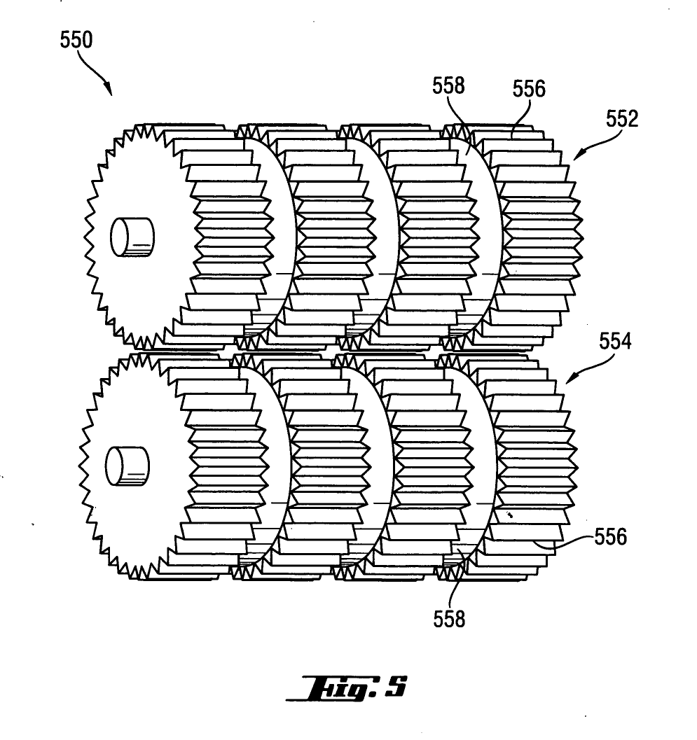

FIG. 5. is another simplified illustration of another apparatus used to form the substrates of the present invention.

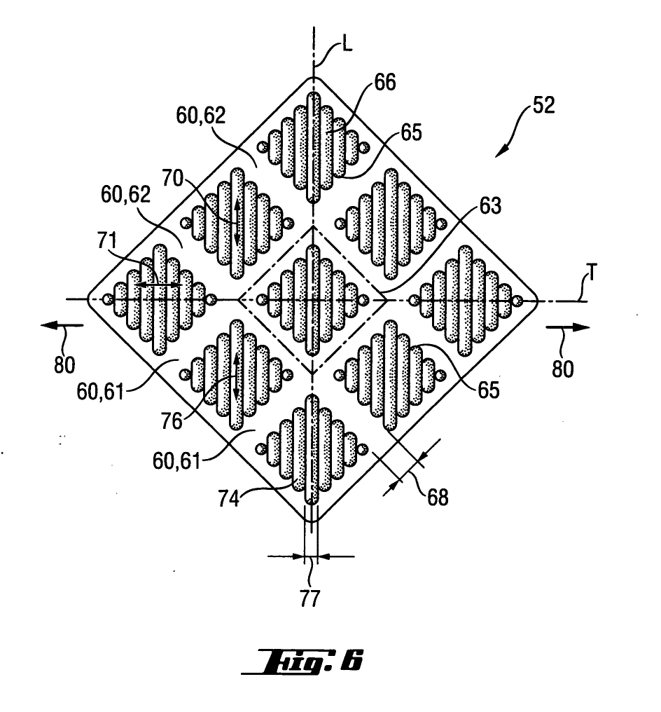

FIG. 6. is a plan view illustration of a preferred embodiment of the substrate of the present invention showing the diamond shaped second regions.

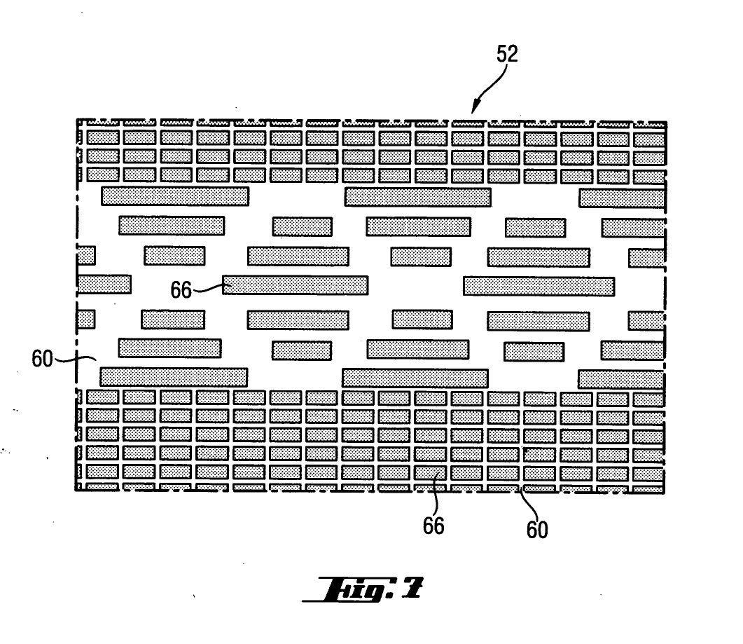

FIG. 7. is a plan view illustration of a preferred embodiment of the substrate of the present inventions showing two patterns of second regions; diamond shaped and rows. The diamond shapes comprise folding protruding elements and are found toward the center of the substrate whereas the rows comprise rib-like protruding elements and are found toward the outer limits of the substrate.

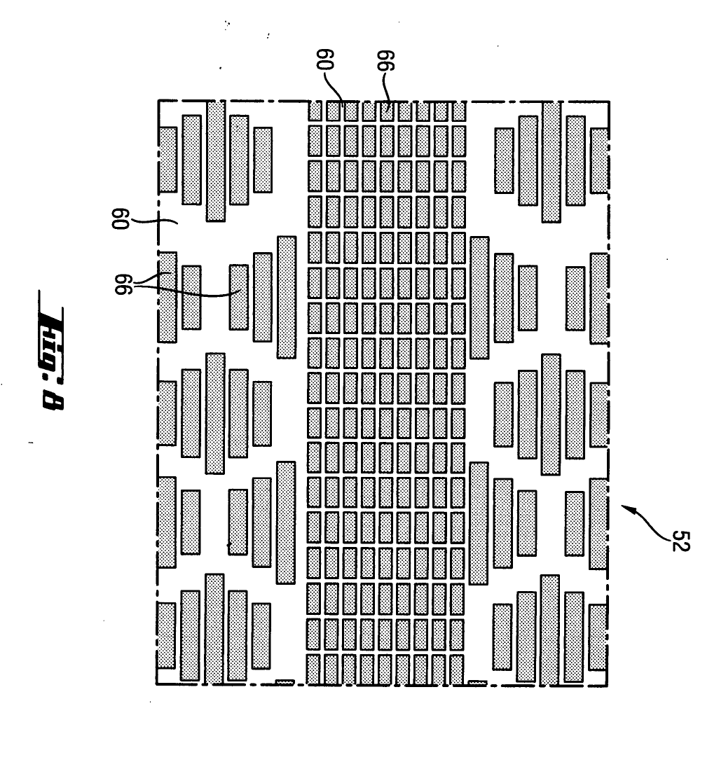

FIG. 8. is a plan view illustration of a preferred embodiment of the substrate of the present inventions showing two patterns of second regions; diamond shaped and rows. The diamond shapes comprise folding protruding elements and are found toward the outer limits of the substrate whereas the rows comprise rib-like protruding elements and are found toward the center of the substrate.

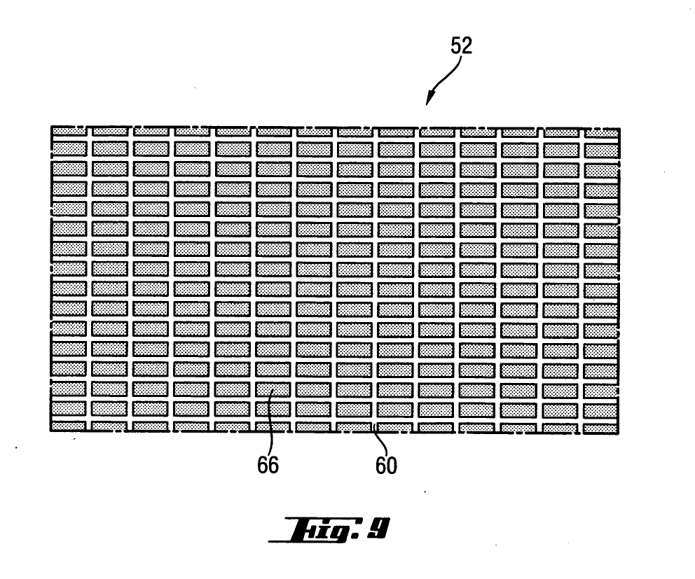

FIG. 9. is a plan view illustration of a preferred embodiment of the substrate of the present inventions showing rib-like rows of protruding elements.

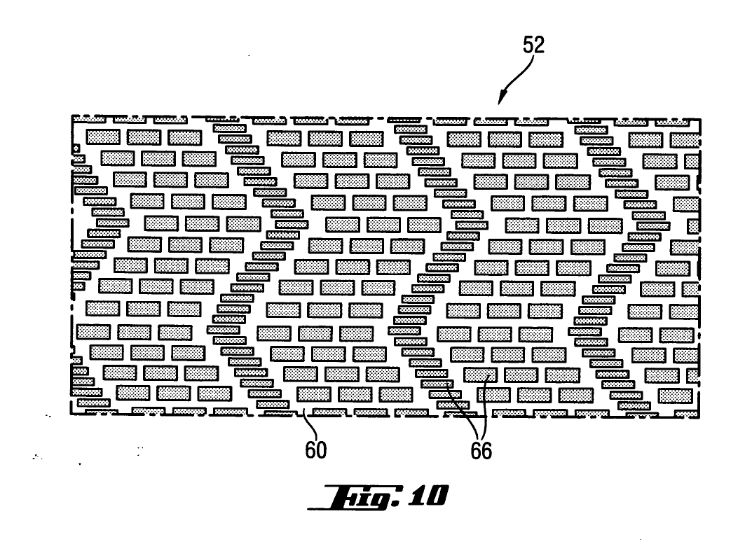

FIG. 10. is a plan view illustration of a preferred embodiment of the substrate of the present inventions showing two patterns of second regions arranged in waves.

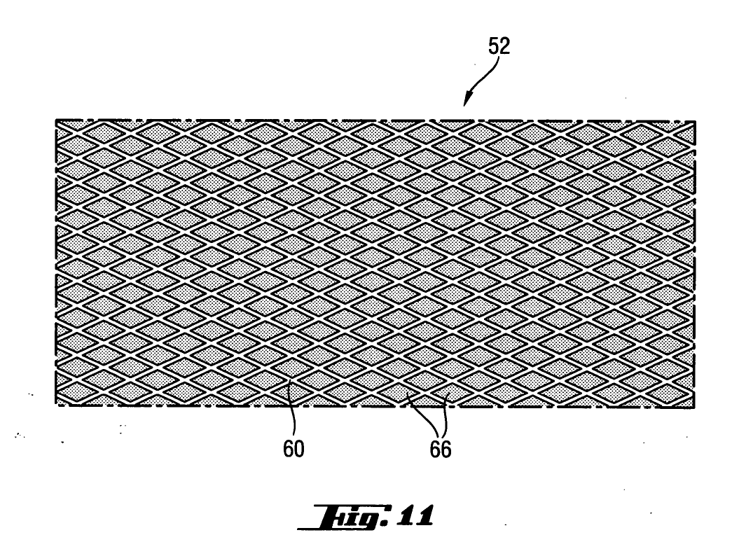

FIG. 11. is a plan view illustration of a preferred embodiment of the substrate of the present inventions showing diamond shaped protruding elements.

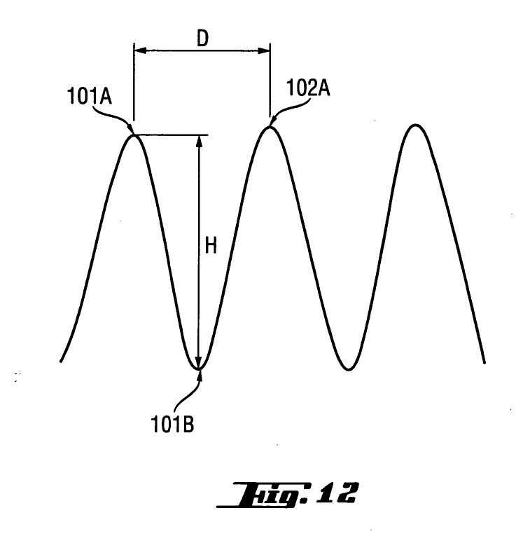

FIG. 12. is a cross sectional illustration of the substrate showing the profile of the protruding elements.

### DETAILED DESCRIPTION OF THE INVENTION

The present invention relates to substrates suitable for use as cleaning sheets in the removal of dust, lint, hair, grass, sand, food crumbs, dirt, soil and other matter of various size, shape, consistency, etc., from a variety of surfaces.

As a result of the ability of the substrates when used as cleaning sheets to reduce, or eliminate, by various means, including removal, collection and entrapment of dust, lint and other airborne matter from surfaces, as well as from the air, the sheets will provide greater reduction in the levels of such materials on surfaces and in the atmosphere, relative to other products and practices for similar cleaning purposes. The use of a low level of additive, uniformly attached on at least one area of the substrate in an effective amount to improve the adherence of soil, especially particulates, and especially those particulates that provoke an allergic reaction, provides a surprising level of control over soil adherence. At least in those areas where the additive is present on the substrate, the low level is important for such use, since, unlike traditional dusting operations where oils are applied as liquids, or as sprays, there is much less danger of creating a visible stain, especially on such non-traditional surfaces, when the substrate is used. The preferred structures also provide benefits by trapping larger particles rather than abrading them to smaller sizes.

Consumers with allergies especially benefit from the use of the substrates herein, since allergens are typically in dust form and it is especially desirable to reduce the level of small particles that are respirable. For this benefit, it is important to use the substrates on a regular basis, and not just when the soil becomes visually apparent, as in prior art procedures.

The substrates of the present invention are suitable for use as preferably disposable dry dusting sheets. The term “disposable” is used herein to describe articles which are not intended to be laundered or otherwise restored or reused (i.e., they are intended to be discarded after a single use, and, preferably, to be recycled, composted or otherwise disposed of in an environmentally compatible manner). Because of their single use nature, low cost materials and methods of construction are highly desirable in disposable articles.

As used herein, the term “Z-dimension” refers to the dimension orthogonal to the length and width of the substrate of the present invention. The Z-dimension usually corresponds to the thickness of the substrate. The term “X-Y dimension” thus refers to the plane orthogonal to the thickness of the substrate and thus usually corresponds to the length and width, respectively, of the substrate.

As used herein, the term “layer” refers to a component of a substrate whose primary dimension is X-Y, i.e., along its length and width. It should be understood that the term layer is not necessarily limited to single layers or sheets of material. Thus the layer can comprise laminates or combinations of several webs of the requisite type of materials. Accordingly, the term “layer” includes the terms “layers” and “layered.”

For purposes of the present invention, an “upper” layer of a substrate is a layer that is relatively further away from the surface that is to be cleaned (i.e., in the implement context, relatively closer to the implement handle during use). The term “lower” layer conversely means a layer of a substrate that is relatively closer to the surface that is to be cleaned (i.e., in the implement context, relatively further away from the implement handle during use). The term “inner” layer means a layer sandwiched between upper and lower layers.

By the term substrate it is meant a single fibrous web or a laminate of two or more webs, at least one of which being a fibrous web. And by the term web it is meant a fibrous web or a film (perforated, apertured, homogeneous, co-extruded or laminated).

By starting substrate it is meant the unformed substrate prior to mechanical manipulation thereof. All percentages, ratios and proportions used herein are by weight unless otherwise specified.

The First and Second Regions

The substrates of the present invention comprise at least a first region and at least a second region. Preferably said substrates comprise a plurality of first and second regions. The substrates are designed such that said second regions are capable of greater geometric deformation than said first regions. As used herein the term “geometric deformation” refers to deformations of the substrate which are generally discernible to the normal naked eye when the substrate or articles embodying the substrate are subjected to an applied elongation force. This is in contrast to “molecular-level deformation” which refers to deformation which occurs on a molecular level and is not discernible to the normal naked eye. That is, even though one may be able to discern the effect of molecular-level deformation, e.g., elongation of the substrate, one is not able to discern the deformation which allows or causes it to happen.

The protruding elements of the second region permit greater “geometric deformation” which results in significantly less resistive forces to an applied elongation than that exhibited by the first region. Types of geometric deformation include, but are not limited to bending, folding, unfolding, and rotating. The second regions of the substrates comprise protruding elements. As used herein, the term “protruding element” refers to an area of formation of ridges and/or furrows on the surface of the substrate. The formation may be above or below the plane of the substrate and may be convex and/or concave. The protruding elements may consists of only slight formation of the substrate, producing a mildly undulating surface. Preferably, the protruding elements are more pronounced however and can be described as rib-like and/or folding elements. Rib-like elements comprise a major axis and a minor axis defining an elongated cuboidal, ellipsoidal or other similar rib-like shape. The major axis and the minor axis of the protruding rib-like elements may each be linear, curvilinear or a combination of linear and curvilinear. Folding elements are greater in height than the rib-like elements and tend to fold over partially or completely obscuring an adjacent first region. In some instances the folding elements may even partially obscure an adjacent protruding element. Each second region of the substrate preferably comprises a plurality of protruding elements. More preferably the protruding elements in each second region are contiguous with no unformed or first regions between them.

The first regions are preferably and most typically visually distinct from the second regions. As used herein, the term “visually distinct” refers to features of the substrate which are readily discernible to the normal naked eye when the substrate or objects embodying the substrate are subjected to normal use.

The first regions, when compared to the second regions, are substantially planar and unformed, comprising no protruding elements. The function of such areas is to provide integrity and strength to the substrate, especially during use. In comparison to the second regions, the first regions are less extensible and less deformable. Hence whilst they may undergo geometric deformation, it is less than what is discernible with respect to the second regions of the substrate. The first regions typically undergoes a molecular-level deformation only and thus the main role of the first regions of the substrate of the present invention is to limit the degree of extensibility of the substrate per se. The second regions by contrast comprise protruding elements which are formed during the manipulation process described below. The protruding elements may appear visually like a region of corrugation comprising ridges and furrows. Said protruding elements are capable of greater geometric deformation than the first regions owing to the existence of the corrugated areas. When a force is applied to the second region of the substrate the protruding areas are stretched, extended or deformed, becoming more planar, to the point of being substantially planar like the first regions. Generally, the greater the size of formation of the protruding element the greater the level of geometric deformation available. The increased three dimensionality provided by the protruding elements of the second region provide a more efficient surface for removal of dirt from a surface when compared to a uniform substrate. The elements conform more easily to irregularities in a substantially planar surface (e.g. cracks, crevices, grout lines in tile floors, etc.) thereby improving soil removal. The rib-like and/or folding protruding elements of the substrates provide further improved conformity to irregularities, especially the deeper irregularities.

The protruding elements in addition to benefits discussed above also provide a system for collection and entrapment of the soils. In a preferred execution, the protruding elements are folding elements as described above, wherein the height of the protruding element is greater than the width. In a particularly preferred embodiment the second region comprises a plurality of contiguous folding protruding elements. In this embodiment the protruding elements fold from the base of the element, covering or at least partially covering, the adjacent folding protruding element, thereby forming a closed or partially closed pocket between the folding elements. In an alternative embodiment, the height of the folding protruding element is greater than the width of an adjacent first region such that when the protruding element bends at the base thereof (i.e., fold over), it will cover, or at least partially cover, the adjacent first region, thereby forming a closed or partially closed pocket between the folding elements and the adjacent first region. In another execution, the height of the protruding element may cover, or at least partially cover, the adjacent first region as well as a portion of the next protruding element. In this embodiment as with the preceding embodiment, the folded protruding element forms a closed or partially closed pocket between the protruding elements and the adjacent protruding element. With current “planar” dusting substrates, soil can be lost from the substrate and/or redeposited when the user changes wiping direction (where potentially the most loss occurs when the wiping direction is changed 180 degrees from previous wiping direction). The benefit of such folding elements in any of the above described embodiments is that, during wiping, soil can be caught in the pockets produced by the folded protruding elements. When the user, changes or reverses the direction of cleaning, the protruding element flips direction or fold over to cover up the soil, thereby forming a substrate pocket in which the soil can be protected from further possible loss and/or redeposition onto the floor. Additionally, when the substrate protruding elements fold over to prevent soil loss, the other side of the protruding element and adjacent first region is exposed for further soil capture. An additional benefit of the above execution is that the soil (e.g., dirt, small stones, etc.) is protected from potentially damaging (i.e., scratching) the surface that is being wiped since the folded protruding element is now covering up the soil.

The first and second regions may be of any suitable shape and arranged in any desirable pattern. Examples of shapes may include strips (FIGS. 7 and 8), waves (FIG. 10) or blocks of first and second regions intermittently spaced or islands of second regions in first regions or vice versa (FIG. 6). In one preferred embodiment strips of the first regions are intermittently spaced between strips of second regions. In another preferred embodiment a portion of the first regions extend in a first direction while the remainder of the first regions extend in a second direction such that the first regions extending in different directions intersect one another at intervals. The second direction is preferably substantially perpendicular to the first direction. In this embodiment the first regions form a boundary completely surrounding the second regions, such that the overall pattern of first and second regions formed resembles a plurality of diamonds (FIGS. 6 and 11). The percentage surface area coverage of the substrate of first and second regions may vary according to the intended use and pattern desired. However, for the purpose of soil removal and collection, it is preferred that the substrate comprises a greater surface area of second regions than first regions. The pattern of first and second regions may in fact provide a performance benefit. And so it is also envisaged that a substrate for use as a cleaning sheet may comprise two or more different patterns across the surface of the substrate. In one example it may be envisaged that a cleaning sheet substrate according to the present invention comprises folding protruding elements, preferably high and/or large folding protruding elements toward the center of the substrate where larger dirt particulates can collect (instead of soil building up in the leading edges of the mop) and less pronounced ridge or rib-like protruding elements in the outer limits of the substrate (FIG. 7). This design of substrate offers (1) more efficient sheet utilization since more of the sheet is exposed for soil capture, (2) less opportunity for large particulate soil and/or soil agglomerates to collect (in piles) at/on the leading edges of the mop, and (3) less opportunity for a pile of dirt on the floor, since more of the soil is captured by the sheet.

Whilst the substrates of the present invention clearly comprise both first and second regions, the substrates also comprise transitional regions which are located at the interface between the first and second regions. The transitional regions will exhibit complex combinations of the behavior of both the first region and the second region. It is recognized that every embodiment of the present invention will have transitional regions, however, the present invention is largely defined by the behavior of the substrate in distinctive regions. Therefore, the description of the present invention will be concerned with the behavior of the substrate in the first and second regions only since the present invention is not significantly dependent upon the complex behavior of the substrate in the transitional regions

Method of Making the Substrates

The substrates of the present invention comprise first and second regions. As discussed above the first regions are substantially unformed or planar, whereas the second regions are formed, comprising protruding elements. The first and second regions of the substrate are formed from a starting substrate that is substantially planar. Said starting substrate is fed through a specially designed machinery which forms the protruding elements of the substrate in predefined areas resulting in the second regions of the substrate. The processes below are described with respect to manipulation of a starting substrate. Said substrate once formed may be used as a cleaning sheet as is or may be a component of a more complex laminate cleaning sheet. In the present description, by the term “formed” substrate (e.g. the substrate is formed) it is meant that the starting substrate has been fed through the machinery described and the protruding elements of the second regions of the substrate have been formed.

Referring now to FIG. 1, there is shown an apparatus 400 used to form the substrate 52 shown in FIG. 6. Apparatus 400, includes intermeshing plates 401, 402. Plates 401, 402 include a plurality of intermeshing teeth 403, 404, respectively. Plates 401, 402 are brought together under pressure to form the substrate of the present invention.

Plate 402 includes toothed regions 407 and grooved regions 408 both of which extend substantially parallel to the longitudinal axis of the plate 401. Within toothed regions 407 of plate 402 there are a plurality of teeth 404. Plate 401 includes teeth 403 which mesh with teeth 404 of plate 402. When a substrate is formed between plates 401, 402 the portions of the starting substrate which are positioned within grooved regions 408 of plate 402 and teeth 403 on plate 401 remain undeformed. These regions correspond with the first regions 60 of the substrate 52 shown in FIG. 6. The portions of the starting substrate positioned between toothed regions 407 of plate 402, (which comprise teeth 404), and teeth 403 of plate 401 are incrementally formed creating the second regions and/or the protruding elements 74 in the second regions 66 of the substrate 52.

The method of formation can be accomplished in a static mode, where one discrete portion of a substrate is formed at a time. An example of such a method is show in FIG. 2. A static press indicated generally as 415 includes an axially moveable plate or member 420 and a stationary plate 422. Plates 401 and 402 are attached to members 420 and 422, respectively. While plates 401 and 402 are separated, the starting substrate is introduced between the plates 401 and 402. The plates are then brought together under a pressure indicated generally as “P”. The upper plate 401 is then lifted axially away from the plate 402 allowing the formed substrate to be removed from between the plates 401 and 402.

Alternatively, the method of formation can be accomplished using a continuous, dynamic press (FIG. 3) for intermittently contacting the moving starting substrate and forming the starting substrate into the formed substrate of the present invention. The starting substrate 406 is fed between plates 401 and 402 in a direction generally indicated by arrow 430. Plate 401 is secured to a pair of rotatably mounted arms 432, 434 which travel in a clockwise direction and which move plate 401 in a clockwise motion. Plate 402 is connected to a pair of rotary arms 436, 438 which travel in a counter clockwise direction moving plate 402 in a counter clockwise motion. Thus, as the starting substrate 406 moves between plates 401 and 402 in the direction indicated by the arrow 430 a portion of the starting substrate between the plates is formed and then released such that the plates 401 and 402 may come together and form another section of starting substrate 406. This method has the benefit of allowing virtually any pattern of any complexity to be formed in a continuous process e.g. uni-directional, bi-directional and multi-directional patterns.

FIG. 4 shows another apparatus generally indicated as 500 for continuously forming the substrate of the present invention. Apparatus 500 includes a pair of rolls 502, 504. Roll 502 includes a plurality of toothed regions 506 and a plurality of grooved regions 508 that extend substantially parallel to a longitudinal axis running through the center of the cylindrical roll 502. Toothed regions 506 include a plurality of teeth 507. Roll 504 includes a plurality of teeth 510 which mesh with teeth 507 on roll 502. As a starting substrate is passed between intermeshing rolls 502 and 504, the grooved regions 508 will leave portions of the starting substrate unformed producing the first regions of the substrate of the present invention. The portion of the starting substrate passing between toothed regions 506 and 510 will be formed by teeth 507 and 510, respectively, producing the second regions of the substrates of the present invention, and more specifically the protruding elements of the present invention.

Alternatively roll 504 may consist of soft rubber. As the starting substrate is passed between toothed roll 502 and rubber roll 504 the starting substrate is mechanically formed into the pattern provided by toothed roll 502. The substrate within the grooved regions 508 will remain unformed, while the starting substrate within the toothed regions 506 will be formed producing the second regions of the substrate of the present invention, and more specifically the protruding elements of the present invention.

Referring now to FIG. 5 there is shown an alternative apparatus generally indicated as 550 for forming the starting substrate into a formed substrate. Apparatus 550 includes a pair of rolls 552, 554. Rolls 552 and 554 each have a plurality of toothed regions 556 and grooved regions 558 extending about the circumference of rolls 552, 554 respectively. As the starting substrate passes between 552, 554 the grooved regions 558 will leave portions of the starting substrate unformed, while the portions of the starting substrate passing between toothed regions 556 will be formed producing the second regions of the substrates of the present invention, and more specifically the protruding elements of the present invention.

The height and frequency of the protruding elements of the substrate is dependent on: (1) tooth pitch meaning the distance from tooth tip to tooth tip; (2) depth of engagement (see distance DOE, FIG. 4a) meaning the extent to which the toothed and grooved regions of the two rolls overlap; and (3) substrate properties (e.g., basis weight, caliper, number of fibers, fiber diameter, fiber types, etc.). During the mechanical manipulation process, the starting substrate is traveling between the upper and lower rolls. While the starting substrate travels between the rolls described, the starting substrate becomes “locked” between the tips of teeth on either roll (i.e., when the starting substrate cannot move in the direction perpendicular to movement of starting substrate through the rolls). From a hardware point of view, the point when starting substrate “lock up” occurs depends on (1) the tooth pitch and (2) depth of engagement. Typically, the smaller the tooth pitch and larger the depth of engagement, yields an earlier starting substrate “lock” occurrence and thus taller and more frequent protruding elements. The greater height and frequency of the protruding elements results in a substrate with greater potential for substrate geometric deformation. From a starting substrate point of view, the thicker the starting substrate, the more fibers, and the greater the basis weight, also, yields an earlier starting substrate “lock” occurrence and thus as above, results in a substrate with greater potential for substrate geometric deformation. Hence in order to produce a substrate with protruding elements, but not being bound to a specific tooth pitch and starting substrate, the depth of engagement of the toothed and grooved regions is preferably in excess of 0.01 inches.

It is clear from the above process that the first regions result from contact with the grooved regions of the roll and are thus unformed and substantially planar. However it may also be envisaged that the first regions comprise a comparatively minor level of formation. In this case, the grooves of the roll may be shallow or comprise an irregular surface such that when the starting substrate is fed through the machinery, the first regions comprise a corresponding irregular surface. Alternatively it may be envisaged that the starting substrate may be fed through a series of manipulation processes. In at least one of these processes the first regions are manipulated so as to be minorly formed. Subjecting the starting substrate to a series of formation manipulation processes allows the manufacturer to produce a substrate comprising more than one pattern. Thus in a first pattern is formed during a first manipulation step and a second pattern is formed during a second manipulation step. It is also conceivable that more than two patterns are applied to the substrate.

As discussed above the use of more than one pattern can provide a performance as well as aesthetic benefit. In addition minor deformation of the first regions may in fact provide a further performance benefit in that said first regions will have even lower density, thus be even more suitable for capturing soil. In all such situations however, said second regions are always visually distinct from said first regions.

In order to make the process feasible for mass production of commercial interest the process must run at a minimum speed of approximately 50 feet/minute. Suitable starting substrates for use in such high speed manipulation of the web(s) are those that can be manipulated at said minimum speed without tearing, perforating, creating holes and/or substantially unacceptable thin regions (i.e. less opaque, lower fiber concentration) in the substrate.

The Substrate Composition

The first and second regions are preferably comprised of the same material composition. The substrate of the present invention is made from at least one fibrous web. It is envisaged that the substrate according to the present invention may be a single fibrous web that has undergone the mechanical manipulation to form the first and second regions of the substrate. Alternatively it can equally be envisaged that the substrate may be composed of a laminate of at least two, more preferably at least three or even more webs, wherein at least one web is a fibrous web. The laminate of webs may be compiled prior to being subjected to the mechanical manipulation to form the first and second regions of the substrate as above. Alternatively the laminate of webs may be compiled at the point where the webs are fed into the machinery. Further still, it can be envisaged that the substrate composed of a single fibrous web or a laminate of two or more webs is subjected to the mechanical manipulation above, and is then used as a component of a more complex cleaning sheet structure.

The substrates of the present invention have low density, meaning that the density of the substrate is no more than 0.15 g/cm³, more preferably no more than 0.12 g/cm³, more preferably no more than 0.1 g/cm³ and most preferably no more than 0.09 g/cm³. Lower density substrates have greater pore volume and are therefore more suitable for collection and entrapment of soil. In addition to the increase in volume for storing said soil, the lower density substrate also results in the fibers entangling with soil particles, etc., further prohibiting redeposition of the soil on the surface cleaned.

The substrates of the present invention are preferably lofty meaning that they have caliper of no less than 0.7 mm, more preferably no less than 0.8 mm and most preferably no less than 0.9 mm. The substrates of the present invention are also preferably resilient, meaning that the substrate substantially reforms its original shape and caliper once a force has been applied to the substrate and then released. One measure of substrate resiliency is the amount of thickness recovery (caliper rebound) exhibited by the substrate once a pressure load (0.066 psi) is removed (measured after 3 min). The substrates of the present invention preferably exhibit caliper rebound of greater than 65%, more preferably greater than 70%, and most preferably greater than 75% of its original caliper. The test methodology for measuring caliper rebound is detailed hereafter. It is also preferable that the protruding elements of the regions of the substrate are resilient, not only so that the substrate can be used to full capacity, but also so as to ensure that the protruding elements can rebound after having been compressed during packaging and storage.

The substrates of the present invention are preferably made using lightly bonded/entangled webs made by various nonwovens processes including, but not limited to air laid, carded, carded thermal bonded, carded chemical bonded, carded through air bonded, melt blown, spunbond, spunlace, and combinations thereof. By ‘lightly bonded/entangled’ it is meant that (1) the fibers are loosely or not bonded/entangled together throughout the thickness (z-plane of the web) of the web and/or (2) the distance between bond/entanglement points are widely spaced apart from each other. The substrates of the present invention preferably have a basis weight of from 10 to 120 grams/meter², more preferably from 15 to 100 grams/meter and most preferably from 20 to 90 grams/meter².

To determine which starting substrates are capable of being manipulated using the above described process, the starting substrates are subjected to the above process of manipulation to determine whether the process will tear, perforate, create holes and/or substantially unacceptable thin regions (i.e., less opaque, lower fiber concentration) in the substrate. The mechanical manipulation process parameters, meaning speed of mechanical manipulation, depth of engagement between two corresponding rolls, tooth pitch, influences the ability of the starting substrate to withstand the rigors of the mechanical manipulation. Due to this complexity, the method of selecting starting substrates is to subject the starting substrate of interest to the mechanical manipulation process to determine if the formed substrate delivers the desired results. Depending on the results of these experiments, various mechanical manipulation process parameters can be adjusted to aid in making a selected starting substrate useful in this process.

Preferred starting substrates comprise webs that can extend or elongate quickly without tearing, perforating, creating holes and/or substantially unacceptable thin regions. Typically the preferred webs should be able to extend about 200% in about 0.01 seconds or less.

Preferred substrate of the present invention comprising at least two different fiber types. By that it is meant that the substrate comprises at least two fiber types that differ from one another by fiber length, fiber diameter (denier), fiber chemistry, fiber finish and mixtures thereof.

Fibers suitable for forming the webs used in the production of the substrates of the present invention are selected from the group consisting of: wood pulp, cotton, wool, and the like, as well as biodegradable fibers, such as polylactic acid fibers, and synthetic fibers such as polyolefins (e.g., polyethylene and polypropylene), polyesters, polyamides, synthetic cellulosics (e.g., RAYON®, Lyocell), cellulose acetate, bicomponent fibers meaning fibers comprising a sheath/core or side by side construction of at least two different materials; and blends thereof and films selected from the group consisting of polyolefin (e.g., polyethylene and polypropylene), polyesters, polyamides, cellulose acetate, glycine, ethyl vinyl acetate, biodegradable films such as polylactic acid and laminates of films (co-extruded films) and mixtures thereof. Preferred fibers for making the substrates of the present invention are synthetic and bicomponent materials, which can be in the form of carded, carded thermal bonded, carded chemical bonded, carded through air bonded, hydroentangled, spunbond, meltblown, airlaid, or other structures.

In a particularly first preferred embodiment, the substrate is composed of a single fibrous web made from a spunbond web. However currently available spunbond webs are often not suitable to withstand the rigors of the mechanical forces imparted to the web during the mechanical manipulation to produce the second region(s) and specifically the protruding elements without the web tearing or perforating. In typical spunbond webs, the fibers are bonded throughout the Z dimension of the web. Hence, in a preferred aspect of the present invention the substrate is made from a single fibrous web made by the spunbond process which has been ‘lightly bonded’ only. With regard to spunbond webs this specifically means that only a portion of the outer surface fibers of the web is bonded, leaving the interior web fibers substantially not bonded. Typically, these bonds are imparted to the fibrous web by passing the web through heated embossed calendar rolls. The extent of web bonding can be adjusted using a number of variables; for example emboss pattern and embossed surface area, temperature, nip pressure, and residence time in the embossed calendar rolls. A method for determining whether a spunbond web is lightly bonded is to rub the web between thumb and finger using average pressure for about 30 seconds. If the web begins to show signs of piling, then it is suitably lightly bonded.

A preferred spunbond web is made using bicomponent fibers. Preferably said bicomponent fibers are selected from the group consisting of polyethylene/polyproylene, polyethylene/polyethylene terephthalate, polyethylene/nylon and combinations thereof. A preferred spunbond web was sourced from BBA Nonwovens, Washougal, Wash. The web was a modified Softspan (tradename) spunbond web, with increased basis weight (range of 30-80 gsm), reduced embossing parameters (nip pressure, emboss temperature) such that the starting substrate when rubbed will readily pill, modified fiber denier (in the range of 1.8 to 5.8 dpf; and mixtures thereof), and modified core/sheath bicomponent ratio in the range of 50/50 to 30/70 PE/PP.

The basis weight of such spunbond substrates is preferably from about 10 to about 120 grams/meter², more preferably from about 15 to about 100 grams/meter², and most preferably from about 20 to about 90 grams/meter².

In another preferred second embodiment the substrate is a laminate of at least two fibrous webs. The webs are layered one on top of the other forming upper, lower and optionally inner layers. Fibers particularly suitable for forming such webs include, for example, natural fibers, e.g. wood pulp, cotton, wool, and the like, as well as biodegradable fibers, such as polylactic acid fibers, and synthetic fibers such as polyolefins (e.g., polyethylene and polypropylene), polyesters, polyamides, synthetic cellulosics (e.g., RAYON®, Lyocell), cellulose acetate, bicomponent fibers, and blends thereof. The webs may be in the form of carded, spunbonded, meltblown, spunlaced, airlaid, carded thermal bonded, carded chemical bonded, carded through air bonding or other structures. The webs once formed are preferably hydroentangled as is well known in the art. As used herein, the term “hydroentangle” means generally a process of treatment of a starting substrate wherein a layer of loose fibrous material (e.g., polyester) is supported on an apertured member and is subjected to water pressures sufficiently great to cause the individual fibers to mechanically entangle with other fibers and possibly other web layers of a substrate. The apertured member can be made from a woven screen, a perforated metal plate, etc.

Preferred starting materials for making the substrates of this embodiment are synthetic materials, which can be in the form of carded, spunbonded, meltblown, airlaid, spunlaced, carded thermal bonded, carded chemical bonded, carded through air bonded or other structures. Particularly preferred are carded webs, especially carded webs made from polyester, bicomponent fibers or mixtures thereof.

A preferred substrate comprises first fibers and second fibers having different denier. The substrate may comprise a web homogeneously comprising first fibers and second fibers or may comprise a first web comprising first fibers and a second web comprising second fibers wherein said first fibers and said second fibers have different denier. The fibers of the webs according to this embodiment preferably have denier of less than 15 denier, more preferably from about 0.3 to about 12, and most preferably from about 0.5 to about 10. The difference in denier between the first and second fibers should preferably be at least about 0.3, more preferably at least about 0.7, most preferably at least about 1 denier. In a preferred embodiment, the first fibers will have a denier of from about 0.5 to about 5 and the second fibers will have a denier of from about 1 to about 10. The substrates will preferably comprise a ratio of first fibers to second fibers of from about 100:1 to about 1:100, more preferably from about 10:1 to about 1:20, and more preferably from about 1:5 to about 1:10, by weight. The thickness of the substrate can be important for both cleaning performance and aesthetics reasons. The combination of fibers having relatively high denier with fibers having relatively low denier can provide the cleaning sheet with the desired caliper. Moreover a substrate comprising fibers having different denier can also provide substrate resilience and particle entrapment properties. Larger denier fibers provide rigidity to the substrate, improving substrate resilience and tend to be useful in entrapment of larger particle sizes. Smaller denier fibers by contrast tend to be useful in entrapment of smaller particle sizes, it is therefore useful to be able to combine both characteristics and thus increase the range of particles that can be entrapped by the substrate

The upper and/or lower layers of webs whilst providing characteristics suitable for cleaning, collection and entrapment of soil, are often not particularly suitable to withstand the rigor of the mechanical manipulation of the process preferred to produce the first and second regions of the substrate. It is therefore preferable to incorporate: (i) a reinforcing web to provide further strength and integrity to the substrate; (ii) an extensible web to provide greater extensibility of the substrate before breaking; or (iii) a reinforcing, extensible web which provides characteristics of both of webs (i) and (ii) as an inner layer.

A reinforcing web is defined as a web which provides additional strength and integrity over that provided by other webs of the substrate. A reinforcing web is especially preferred wherein the upper and/or lower layer comprises carded staple fibers, such as carded staple polyester fibers. Carded staple fibers, while being particularly effective for removing particulate matter from surfaces, can result in a cleaning sheet without sufficient strength and integrity. The reinforcing web tends to provide enhanced strength and integrity to the resulting substrate, which is especially important when it is used for cleaning household surfaces such as hardwood floors, ceramic tile (with grout), furniture surfaces, and the like. The reinforcing web typically comprises webs selected from the group consisting of carded thermal bonded, carded chemical bonded, carded thorough air bonded, meltblown, spunbonded, hydroentangled, extruded films and mixtures thereof. The reinforcing web is preferably free of non-random perforations or open areas. A preferred reinforcing web herein will preferably use fibers having a denier of less than 15, more preferably from about 0.3 to about 12, and even more preferably from about 0.4 to about 10. A preferred reinforcing web is a 100% polypropylene spunbond.

An extensible web is defined as a web which provides additional extensibility/stretch over that provided by other webs of the substrate. Incorporating such an extensible web into a substrate, enable the substrate to be extendable without tearing, perforating, creating holes and/or unacceptably thin regions. Incorporation of an extensible web into the substrate therefore results in the ability of the manufacturer to use higher manufacturing speeds and thus increase yield. Such a substrate will also exhibit a greater degree of geometric deformation. An extensible web is especially preferred wherein the upper and/or lower layer comprises carded staple fibers, such as carded staple polyester fibers. The extensible web typically comprises webs selected from the group consisting of carded thermal bond, carded chemical bond, carded through air bonded, meltblown, spunbonded, hydroentangled, and mixtures thereof. In a preferred embodiment the extensible web is made of from polyethylene (PE), polypropylene (PP), and bicomponent fibers (PE/PP, PE/PET, PE/Nylon), Nylon and mixtures thereof. The preferred extensible web herein will preferably use fibers having a denier of less than 15, more preferably from about 0.3 to about 12, and even more preferably from about 0.4 to about 10. A preferred extensible web is a spunbond web made from bicomponent fibers 50% PE/50% PP.

A reinforcing extensible web comprises characteristics of both the reinforcing and extensible webs. A preferred example of such a web is an area bonded spunbond fibrous web having a basis weight of 17 g/m² and comprising polyester fibers having a denier per filament of about 6.0. Said web is available form BBA under the tradename Remay 1054W.

When the substrate is a laminate of two or more webs the basis weight of the substrate is preferably from about 10 to about 120 grams/meter², more preferably from about 15 to about 100 grams/meter², and most preferably from about 20 to about 90 grams/meter².

The substrate of this embodiment preferably comprises at least three fibrous webs. The substrate comprises two fibrous webs and a reinforcing, extensible or reinforcing extensible fibrous web. The webs are preferably positioned such that the two fibrous webs are the upper and lower layer and the reinforcing web is the inner layer. The fibrous webs preferably both comprise carded staple fibers, and the reinforcing fibrous web preferably comprises spunbond or thermally bonded fibers. All three webs are then hydroentangled to form the substrate.

In another preferred embodiment the substrate comprises three webs, the upper and lower webs being fibrous in nature and the inner web being a film.

The present substrates can further comprise four, five, six, or more webs (or layers). In the preferred embodiments that comprise an upper and lower fibrous web and an inner fibrous web selected from those discussed above, the inner layer web will generally have a basis weight that is from about 10% to about 85%, preferably from about 15% to about 80%, and more preferably from about 20% to about 75%, of the total aggregate basis weight of the substrate.

The three dimensionality of the substrate of the present invention can be described in terms of the “Average Height Differential” of a peak of a protruding element and an adjacent valley, as well as in terms of the “Average Peak-to-Peak Distance” between peaks of adjacent protruding elements. Referring to FIG. 12, the height differential with respect to a peak 101A/valley 101B pair is the distance H. The peak-to-peak distance between an adjacent pair of peaks 101A and 102A is indicated as distance D. The “Average Height Differential” and the “Average Peak-to-Peak Distance” of the protruding element of the substrate are measured as set forth below in the “Test Methods” described hereinafter. The “Surface Topography Index” of the substrate is the ratio obtained by dividing the Average Height Differential of the substrate by the Average Peak to Peak Distance of the substrate.

It will be apparent to one skilled in the art that there will be relatively small regions of peaks and valleys that are not significant enough to be considered as providing macroscopic three dimensionality. Such fluctuations and variations are a normal and expected result of the manufacturing process and are not considered when measuring Surface Topography Index.

Without being limited by theory, it is believed that the Surface Topography Index is a measure of the effectiveness of the macroscopically three dimensional surface in receiving and containing material in the valleys of the surface. A relatively high value of Average Height Differential for a given Average Peak to Peak Distance provides deep, narrow valleys which can trap and hold materials. Accordingly, a relatively high value of Surface Topography Index is believed to indicate effective capture of materials during wiping.

The Average Peak to Peak Distance of the protruding elements of the second region will be at least about 0.5 mm, more preferably at least about 1.0 mm, and still more preferably at least about 1.5 mm. In one embodiment, the Average Peak to Peak distance is from about 0.5 to about 30 mm, particularly from about 1.0 to about 25 mm, more particularly from about 1.5 to about 20 mm. The Surface Topography Index of the second region will preferably be from about 0.01 to about 100, more preferably from about 0.05 to about 75, still more preferably from about 0.75 to about 60, still more preferably from about 0.8 to about 50. While not critical, the second region will preferably have an Average Height Differential of at least about 0.3 mm, more preferably at least about 0.5 mm, and still more preferably at least about 0.7 mm. The Average Height Differential of the second region will typically be from about 0.3 to about 12 mm, more typically from about 0.5 to about 10 mm.

Referring to FIG. 6, substrate 52 includes distinct regions; a plurality of first regions 60 and a plurality of second regions 66. Substrate 52 also includes transitional regions 65 which are located at the interface between the first regions 60 and the second regions 66. However as discussed above the present invention is largely defined by the behavior of the substrate in distinctive regions (e.g., first regions 60 and second regions 66). Therefore, the present description will be concerned with the behavior of the substrate in the first regions 60 and the second regions 66 only.

Substrate 52 has a first surface, (facing the viewer in FIG. 6), and an opposing second surface (not shown). In the preferred embodiment shown in FIG. 6, the substrate includes a plurality of first regions 60 and a plurality of second regions 66. A portion of the first regions 60, indicated generally as 61, are substantially linear and extend in a first direction. The remaining first regions 60, indicated generally as 62, are substantially linear and extend in a second direction which is preferably substantially perpendicular to the first direction. While it is preferred that the first direction be perpendicular to the second direction, other angular relationships between the first direction and the second direction may be suitable so long as the first regions 61 and 62 intersect one another. Preferably, the angles between the first and second directions ranges from about 45° to about 135°, with 90° being the most preferred. The intersection of the first regions 61 and 62 forms a boundary, indicated by phantom line 63 in FIG. 6, which completely surrounds the second regions 66.

Preferably, the width 68 of the first regions 60 is from about 0.01 inches to about 1 inches, and more preferably from about 0.03 inches to about 0.75 inches. However, other width dimensions for the first regions 60 may be suitable. Because the first regions 61 and 62 are perpendicular to one another and equally spaced apart, the second regions have a square shape. However, other shapes for the second region 66 are suitable and may be achieved by changing the spacing between the first regions and/or the alignment of the first regions 61 and 62 with respect to one another, as discussed above. The second regions 66 have a first axis 70 and a second axis 71. The first axis 70 is substantially parallel to the longitudinal axis (L) of the substrate 52, while the second axis 71 is substantially parallel to the transverse axis (T) of the substrate 52.

In the illustrated embodiment, the substrate 52 has been “formed” such that the substrate 52 exhibits a resistive force along an axis, which in the case of the illustrated embodiment is substantially parallel to the transverse axis of the substrate, when subjected to an applied axial elongation force in a direction substantially parallel to the transverse axis (T). As used herein, the term “formed” refers to the creation of a desired structure or geometry upon a substrate that will substantially retain the desired structure or geometry when it is not subjected to any externally applied elongations or forces. A substrate of the present invention is comprised of a plurality of first regions and a plurality of second regions, wherein the first regions are visually distinct from the second regions.

In the preferred embodiment shown in FIG. 6 the first regions 60 are in substantially the same condition before and after the formation step undergone by substrate 52. The second regions 66 include protruding elements, preferably a plurality of said elements, more preferably said elements are rib-like 74 and/or folding elements. Rib-like protruding elements 74 have a first or major axis 76 which is substantially parallel to the longitudinal axis of the web 52 and a second or minor axis 71 which is substantially parallel to the transverse axis of the web 52.

The protruding elements 74 in the second region 66 may be separated from one another by unformed areas or simply spacing areas. Preferably, the protruding elements 74 are adjacent to one another and are separated by an unformed area of less than 0.10 inches as measured perpendicular to the major axis 76 of the protruding elements 74, and more preferably, the protruding elements 74 are contiguous having no unformed areas between them.

Optional Additive Material

The cleaning performance of any of the substrates of the present invention can be further enhanced by treating the substrates with any of a variety of additives, including surfactants or lubricants, that enhance adherence of soils to the substrate. When utilized, such additives are added to the substrate at a level sufficient to enhance the ability of the substrate to adhere soils. Such additives are preferably applied to the substrate at an add-on level of at least about 0.01%, more preferably at least about 0.1%, more preferably at least about 0.5%, more preferably at least about 1%, still more preferably at least about 3%, still more preferably at least about 4%, by weight. Typically, the add-on level is from about 0.1 to about 25%, more preferably from about 0.5 to about 20%, more preferably from about 1 to about 15%, still more preferably from about 3 to about 10%, still more preferably from about 4 to about 8%, and most preferably from about 4 to about 6%, by weight. A preferred additive is a wax or a mixture of an oil (e.g., mineral oil, petroleum jelly, etc.) and a wax. Suitable waxes include various types of hydrocarbons, as well as esters of certain fatty acids (e.g., saturated triglycerides) and fatty alcohols. They can be derived from natural sources (i.e., animal, vegetable or mineral) or can be synthesized. Mixtures of these various waxes can also be used. Some representative animal and vegetable waxes that can be used in the present invention include beeswax, carnauba, spermaceti, lanolin, shellac wax, candelilla, and the like. Representative waxes from mineral sources that can be used in the present invention include petroleum-based waxes such as paraffin, petrolatum and microcrystalline wax, and fossil or earth waxes such as white ceresine wax, yellow ceresine wax, white ozokerite wax, and the like. Representative synthetic waxes that can be used in the present invention include ethylenic polymers such as polyethylene wax, chlorinated naphthalenes such as “Halowax,” hydrocarbon type waxes made by Fischer-Tropsch synthesis, and the like.

When a mixture of mineral oil and wax is utilized, the components will preferably be mixed in a ratio of oil to wax of from about 1:99 to about 99:1, more preferably from about 1:99 to about 10:1, still more preferably from about 1:99 to about 3:7, by weight. In a particularly preferred embodiment, the ratio of oil to wax is about 3:7, by weight, and the additive is applied at an add-on level of about 5%, by weight. A preferred mixture is a 3:7 mixture of mineral oil and paraffin wax.

Particularly enhanced cleaning performance is achieved when macroscopic three-dimensionality and additive are provided in a single substrate. As discussed hereinbefore, these low levels are especially desirable when the additives are applied at an effective level and preferably in a substantially uniform way to at least one discrete continuous area of the sheet. Use of the preferred lower levels, especially of additives that improve adherence of soil to the sheet, provides surprisingly good cleaning, dust suppression in the air, preferred consumer impressions, especially tactile impressions, and, in addition, the additive can provide a means for incorporating and attaching perfumes, pest control ingredients, antimicrobials, including fungicides, and a host of other beneficial ingredients, especially those that are soluble, or dispersible, in the additive. These benefits are by way of example only. Low levels of additives are especially desirable where the additive can have adverse effects on the substrate, the packaging, and/or the surfaces that are treated.

Application of these additives preferably means applying at least a substantial amount of the additive at points “inside” the substrate structure. It is an especial advantage of the three dimensional structure of the present substrate that the amount of additive that is in contact with the surface being cleaned and/or the package, is limited, so that additives that could cause damage, or interfere with the function of the surface, can only cause limited, or no, adverse effects. It is also preferred that additive is applied to the peaks and/or base of the protruding elements of the present substrates. The presence of the additive inside and outside the substrate structure is beneficial in that soil adheres more readily to and is less likely to be displaced from areas of substrate where additive has been applied.

Packaging

The invention also comprises packages containing cleaning sheets substrates of the present invention. The packages being in association with information that will inform the consumer, by words and/or by pictures, that use of the sheets will provide cleaning benefits which include soil (e.g., dust, lint, etc.) removal and/or entrapment and this information can comprise the claim of superiority over other cleaning products. In a highly desirable variation, the package bears the information that informs the consumer that the use of the cleaning sheet provides reduced levels of dust and other airborne matter in the atmosphere. It is very important that the consumer be advised of the potential to use the sheets on non-traditional surfaces, including fabrics, pets, etc., to ensure that the full benefits of the sheets is realized. Accordingly, the use of packages in association with information that will inform the consumer, by words and/or by pictures, that use of the compositions will provide benefits such as improved cleaning, reduction of particulate soil in the air, etc. as discussed herein, is important. The information can include, e.g., advertising in all of the usual media, as well as statements and icons on the package, or the sheet itself, to inform the consumer.

Cleaning Implements

The substrates of the present invention are suitable for use as cleaning sheets. When used for cleaning surfaces such as floors, an implement may be useful, so that the user does not have to lower themselves to the floor. In this regard, it is envisaged that the substrates of the present invention are suitable for use with a cleaning implement. Typical cleaning implements comprise a handle, a mop head, and a means of fastening, preferably removable fastening, of the cleaning sheet substrate of the present invention to the mop head.

The handle of the cleaning implement comprises any elongated, durable material that will provide ergonomically practical cleaning. The length of the handle will be dictated by the end-use of the implement. To facilitate ease of use, the mop head can be pivotably attached to the handle using known joint assemblies. Any suitable means for attaching the cleaning sheet to the mop head can be utilized, so long as the cleaning sheet remains affixed during the cleaning process. Examples of suitable fastening means include clamps, hooks & loops (e.g., VELCRO®), and the like. In a preferred embodiment, the mop head will comprise “grippers” on its upper surface to keep the sheet mechanically attached to the mop head during the rigors of cleaning. The grippers will also readily release the sheet for convenient removal and disposable. Preferred grippers are described in co-pending U.S. application Ser. No. 09/374,714 filed Aug. 13, 1999 by Kingry et al., which is incorporated herein by reference.

To further improve glide characteristics and cleaning performance when a present cleaning sheet is attached to a cleaning implement, the mop head of the cleaning implement can have curved profile on the bottom surface of the mop head. Suitable mop heads have curved bottom surfaces are described in co-pending U.S. application Ser. No. 09/821,953 filed Mar. 30, 2001 by Kacher et al., which is incorporated herein by reference.

Suitable cleaning implements are shown in U.S. Design Pat. Nos. D-409,343; and D-423,742; which are incorporated herein by reference.

### EXAMPLES

The following Examples I-III are non-limiting examples of the substrates of the present invention. Each substrate once produced is subjected to the process described above to form the first and second regions of the substrates. Examples of suitable patterns are shown in FIGS. 6 to 11.

Examples I and II describe a substrate comprising a first fibrous web, a second fibrous web, and a third reinforcing fibrous web, wherein the first and second fibrous webs are the same material. The first, second, and third fibrous webs are placed on top of a forming belt, with the third reinforcing fibrous web being positioned in between the first fibrous web and the second fibrous web. The forming belt is a 100×90 mesh screen. The webs are then hydroentangled and dried. The water entangling process causes the fibers of the first and second fibrous webs to become intertangled and to also become intertangled with the fibers of the reinforcing fibrous web. The substrate is then optionally surface coated (by, e.g., printing, spraying, etc.) with 5%, by weight, of a 3:7 mixture of mineral oil and paraffin wax. Finally the starting substrate prepared as above is subjected to the forming process described herein resulting in a substrate with first and second regions comprising protruding elements.

### Example I

| First/Second Fibrous Web: | Carded fibrous web having a |
|---|---|
| | basis weight of 20 g/m² and |
| | comprising staple polyester |
| | fibers having a diameter of |
| | 1.5 dpf and length of 37 mm |
| | (Wellman Type 203) |
| Third Reinforcing Fibrous | Lightly thermally point bonded |
| Web: | spunbond fibrous web having |
| | basis weight of 30 g/m² and |
| | comprising 50/50 polyethylene/ |
| | polypropylene bicomponent fibers |
| | (sheath/core) having a nominal |
| | diameter of about 3.1. |
| Total Aggregate Basis Weight: | 70 g/m² |
| Substrate Pattern: | Large Diamond |
| Caliper under 0.035 psi load: | 1.87 mm |
| Peak to Peak | 4.32 mm |
| Average Height Differential | 2.40 mm |
| Topography Index: | 0.55 |

### Example II

| First/Second Fibrous Web: | Carded fibrous web having a |
|---|---|
| | basis weight of 25.5 g/m² |
| | and comprising staple |
| | polyester fibers having a |
| | diameter of 1.5 dpf and |
| | length of 37 mm (Wellman |
| | Type 203) |
| Third Reinforcing Fibrous Web: | Area bonded spunbond fibrous |
| | web having a basis weight of |
| | 17 g/m² and comprising |
| | polyester fiber having |
| | a denier per filament of |
| | about 6.0. (Remay 1054W) |
| Total Aggregate Basis Weight: | 68 g/m² |
| Substrate Pattern: | Large Diamond |
| Caliper under 0.035 psi load: | 3.26 mm |
| Peak to Peak Distance | 4.15 mm |
| Average Height Differential | 3.25 mm |
| Topography Index | 0.78 |

### Example III

Single fibrous web: lightly thermally point bonded spunbond comprising 50/50 polyethylene/polypropylene bicomponent fibers (sheath/core) having a nominal diameter of about 3.1 with 18% bond area. (modified Softspan from BBA, Washougal, Wash.)

| Substrate Basis Weight: | 72 g/m² |
|---|---|
| Caliper under 0.035 psi load: | 1.76 mm |
| Substrate Pattern Style | Large Diamond |
| Peak to Peak Distance | 3.63 mm |
| Average Height Differential | 1.67 mm |
| Topography Index | 0.46 |

Test Methodology
A. Average Height Differential

Average Height Differential is determined by using a video measuring system, SmartScope (serial number 508061104), made by Optical Gauging Products Incorporated, Rochester N.Y. equipped with Smart Scope Measurement Software version 4.32. This procedure involves locating a peak or valley region of the sheet, focusing the video measuring system and zeroing the Z-dimension on the measuring device. The video measuring is then moved to an adjacent valley or peak region, respectively, and the microscope is refocused. To measure the average height differential, (i.e., Z directional depth) focus on the peak of the protruding element of interest, and zero the Z-axis. Focus downward until the next point of interest (base of adjacent valley; between the two protruding elements) is in focus. Distance moved will be displayed at the bottom of the screen in millimeters.

The display of the instrument indicates the height difference between this peak/valley or valley/peak pair. This measurement is repeated at least 5 times, at random locations on the sheet, and the Average Height Differential is the average of these measurements.

B. Peak-to-Peak Distance

The above instrument can be used to measure peak-to-peak distance. The magnification used should be sufficient to readily measure the distance between two adjacent peaks. To measure the Peak-to-Peak distance, focus the scope on the top of one peak of a protruding element. Line up the reference point of interest, i.e. the peak of a protruding element, with the vertical line on screen. Depending on the direction measured to the adjacent peak, zero the X- or Y-axis. Move sample stage until the next measuring point, i.e. the peak of the next protruding element, lines up with the vertical line on the screen. The distance between the peaks of the protruding elements will be displayed at the bottom of the screen in millimeters. This measurement is repeated at least 5 times, at random locations on the sheet, and the Average Peak-to-Peak Distance is the average of these measurements.

A number of measurements of peak-to-peak and height differential are taken and the average calculated. These values are used to calculate the topography index for region two of the substrate.

C. Substrate Caliper Rebound Test Methodology:

This test is based on measuring the thickness of the finished substrate before and after a pressure load has been applied and subsequently removed. The percentage recovery of substrate thickness after the pressure load has been removed provided a measure of caliper rebound.

The thickness of the substrate is determined using a modified digital Mitutoyo Caliper gauge (Mitutoyo Digimatic Indicator, available from Measure-All-Inc, Fairfield, Ohio, Catalog number 543-272 with tension spring removed), which is lowered very slowly to the surface of the substrate. To ensure accuracy, the substrate is supported by an 8 inch by 12 inch granite base (available from Measure-All-Inc, Fairfield, Ohio, Catalog number 60812-IRS). Additionally, the digital caliper gauge utilizes the following accessories: (1) Ono Sokki Release Cable [catalog number AA-816], (2) 1 inch extension [catalog number 20-278-8], (3) 1.596 inch diameter contact point [catalog number P-500A-1.596], (4) swivel contact point adapter [catalog number 89-050022] and (5) weight stud [catalog number 10175W]. All these component can be obtained from Measure-All Inc. Fairfield, Ohio. The substrate is placed under the digital Mitutoyo Caliper gauge without any additional weights (pressure of gauge foot is under 0.038 psi) to measure initial thickness of the substrate. A weight of known amount is then added to bring total foot pressure to 0.066 psi. The weight was left on the foot and substrate for 10 minutes, in order to simulate a typical consumer usage period for floor wiping. At the end of the ten-minute period, the additional weight is removed, and the caliper of the sheet was again measured (without any additional weights, nominally under 0.038 psi). Upon weight removal, the “rebound” caliper was recorded every 30 s for up to 3 minutes. Caliper rebound is calculated by dividing the substrate caliper after 3 minutes of weight removal by the initial “no-load” caliper.

D. Thickness, Basis Weight, and Density Methods

All substrate thickness, basis weight, and density calculations are based on measurements with the substrate under a 0.038 psi load.

The thickness of the substrate is measured by utilizing the same test instrument as described above in the “Substrate Caliper Rebound Test Methodology.” The finished substrate is placed under the digital Mitutoyo Caliper gauge without any additional weights (pressure of gauge foot is under 0.038 psi) to measure the thickness of the substrate. The recorded units of the thickness measurement is in millimeters.

The basis weight of the finished substrates is determined from the measuring the weight (in grams) of a finished substrate cut to 100 mm by 100 mm. The basis weight (reported in grams/meter²) is then calculated by the following:

$$Basis Weight = \frac{Weight of Sample}{Area of Sample}$$

The density of the finished substrate is calculated from dividing the basis weight (calculated from above) by the thickness of the substrate. The density (reported in grams/centimeter³) is calculated by the following:

$$Density = \frac{Basis Weight}{Thickness \times 1 \text{,} 000}$$

1. A nonwoven substrate suitable for use as a cleaning sheet having density of no more than about 0.15 g/cm³ and comprising at least one fibrous web, said substrate further comprising at least one first region and at least one second region wherein said at least one second region comprises protruding elements and is capable of greater geometric deformation than said at least one first region wherein said substrate has caliper of no less than about 0.7 mm and wherein said substrate exhibits caliper rebound of greater than about 65%, and wherein at least a portion of said protruding elements fold in use to cover adjacent first regions thereby forming pockets suitable for collection and entrapment of soil.

2. A nonwoven substrate according to claim 1 wherein said first regions and said second regions are visually distinct from one another.

3. A nonwoven substrate according to claim 1 wherein the first and second regions are comprised of the same material composition.

4. A nonwoven substrate according to claim 1 wherein at least one second region comprises protruding rib-like elements.

5. A nonwoven substrate according to claim 4 wherein said protruding elements are contiguous with no first regions between them.

6. A nonwoven substrate according to claim 4 wherein said protruding elements are contiguous with no unformed regions between them.

7. A nonwoven substrate suitable for use as a cleaning sheet having density of no more than about 0.15 g/cm³ and comprising at least one fibrous web, said substrate further comprising at least one first region and at least one second region wherein said at least one second region comprises protruding elements which, in use, exhibit greater geometric deformation than said at least one first region, wherein said substrate has caliper of no less than about 0.7 mm and wherein said substrate exhibits caliper rebound of greater than about 65%, and wherein at least a portion of said protruding elements are capable of folding to cover an adjacent contiguous protruding elements, forming pockets suitable for collection and entrapment of soil.

8. (canceled)

9. A nonwoven substrate according to claim 1 wherein at least a portion of said protruding elements are capable of folding to cover an adjacent first region and adjacent protruding element, forming pockets suitable for collection and entrapment of soil.

10. A nonwoven substrate according to claim 1 wherein the first and second regions are arranged in strips across the substrate.

11. A nonwoven substrate according to claim 1 wherein the first and second regions are arranged in waves across the substrate.

12. A nonwoven substrate according to claim 1 wherein a portion of said first regions extend in a first direction while the remainder of said first regions extend in a second direction which intersects said first direction at intervals and said first regions form a boundary at least partially surrounding said second regions.

13. A nonwoven substrate according to claim 1 wherein said substrate has density of no more than about 0.12 g/cm3.

14. (canceled)

15. (canceled)

16. A nonwoven substrate according to claim 1 wherein the substrate has basis weight of from about 10 to about 120 grams/meter2.

17. A nonwoven substrate according to claim 1 comprising at least two different fiber types, the fibers differing from one another by at least one of: (i) fiber length; (ii) fiber diameter; (iii) fiber chemistry; (iv) fiber finish; and (v) mixtures thereof.

18. A nonwoven substrate according to claim 1 wherein said substrate is composed of at least one lightly bonded web.

19. A nonwoven substrate according to claim 1 wherein said substrate is composed of at least one lightly entangled web.

20. A nonwoven substrate according to claim 1 wherein said substrate is a single fibrous web.

21. A nonwoven substrate according to claim 20, wherein said web is spunbond.

22. A nonwoven substrate according to claim 1 wherein the substrate is a laminate of webs comprising at least one fibrous web.

23. A nonwoven substrate according to claim 1 wherein the substrate is a laminate of at least a fibrous web and a reinforcing web.

24. A nonwoven substrate according to claim 23 wherein said substrate comprising at least two fibrous webs and a reinforcing web, wherein said reinforcing web is sandwiched between said fibrous webs.

25. A nonwoven substrate according to claim 1 wherein the substrate is a laminate of at least a fibrous web and an extensible web.

26. A nonwoven substrate according to claim 25 wherein said substrate comprising at least two fibrous webs and an extensible web, wherein said extensible web is sandwiched between said fibrous webs.

27. A nonwoven substrate according to claim 1 wherein the substrate is a laminate of at least a fibrous web and a reinforcing extensible web.

28. A nonwoven substrate according to claim 27 wherein said substrate comprising at least two fibrous webs and a reinforcing extensible web, wherein said reinforcing extensible web is sandwiched between said fibrous webs.

29. A nonwoven substrate according to claim 23 wherein said reinforcing web is composed of spunbond fibers.

30. A nonwoven web according to any of claims 23 wherein the fibrous webs comprise carded staple fibers and are formed by hydroentanglement and the reinforcing web is composed of spunbond fibers and wherein the laminate of webs are subsequently hydroentangled together.

31. A cleaning sheet comprising the substrate of claim 1.

32. A process of cleaning, preferably dry dusting, a soiled surface by wiping a substrate according to claim 1 over said surface.

33. (canceled)

34. (canceled)

35. A nonwoven web according to claim 1 wherein said substrate has a caliper of no less than about 0.8 mm.

36. A nonwoven web according to claim 35 wherein said substrate has a caliper of no less than about 0.9 mm.

37. A nonwoven web according to claim 1 wherein said substrate exhibits caliper rebound of greater than about 70%.

38. A nonwoven web according to claim 37 wherein said substrate exhibits caliper rebound of greater than about 75%.
